(19) United States
(12) Patent Application Publication
(10) Pub. No.: US 2016/0023485 A1
(43) Pub. Date: Jan. 28, 2016

(54) Ticket Printer

(71) Applicant: CUSTOM S.P.A., Fontevivo (Parma) (IT)

(72) Inventor: Alberto Campanini, Fidenza (Parma) (IT)

(73) Assignee: Custom S.P.A., Fontevino (Parma) (IT)

(21) Appl. No.: 14/837,054

(22) PCT Filed: Feb. 12, 2014
(86) PCT No.: PCT/IB2014/058937

§ 371 Date: Aug. 27, 2015

(30) Foreign Application Priority Data
Mar. 1, 2013 (IT) MO2013A000056

(51) Int. Cl. B41J 13/00

(52) U.S. Cl. CPC B41J 13/0009

(57) ABSTRACT

A ticket printer that includes a plurality of LEDs for emitting light that is visible to a user removing a ticket, wherein the printer is able to transfer information to the exterior, using the light of the LEDs without adding further light emitting means, by means of a modulator that enables the LEDs to emit a pulsed light signal that contains information on the identity of the printer and which can be received and read by an external decoder.

### FIELD OF THE INVENTION

The invention relates to a printer, in particular for dispensing, through an outlet, printed documents such as, for example, tickets, receipts or slips.

### BACKGROUND OF THE INVENTION

Specifically but not exclusively, the invention can be applied to a distributor of tickets, receipts or slips located in a public place, for example self-service kiosks (information, service or other types of kiosk), bank counters or instant teller machines, terminals for paying for parking or public transport, access control systems, gaming machines, automatic distributors in general, etc.

In particular, the present invention refers to a printer made in accordance with the preamble of the first claim. Such a printer is already known, for example from the patent publication FR 2728988 A1.

### SUMMARY OF THE INVENTION

One object of the invention is to make a printer that is able to transfer information to the exterior simply and reliably.

One advantage is making a printer that is easily identifiable and distinguishable in a certain and reliable manner from a counterfeited clone.

One advantage is enabling the transfer of information using the signal emitting device that are normally already present in a printer and without adding further signal emitting device.

One advantage is enabling information to be transferred by a light signal emitting device that is normally used to emit light signals that are visible to a user removing a printed document from the printer.

One advantage is providing a printer that is able to emit modulated signals to the exterior that are invisible to the naked eye and/or contain useful information, for example information relating to the origin and/or to the use of the printer.

One advantage is that the information transferred outside the printer can be received and read by an external reader (decoder).

One advantage is making a printer available that is able to transmit information at a distance in a wireless manner.

One advantage is providing a printer that is able to transmit information on the history of the printer, in particular relating to statistical data (for example, the number of given operations performed by the printer over a given time) or information on production data (for example serial number, production batch, purchase date, installation date, etc).

One advantage is enabling information to be transmitted outside the printer in a form that is encrypted and readable by a decoder.

One advantage is protecting in a simple and reliable manner the brand of the manufacturer of the printer and enabling product traceability.

Such objects and advantages, and still others, are achieved by the printer according to one or more of the claims set out below.

In one example, the printer comprises at least one light source, for example one or more LEDs, having a visible signalling operating mode in which it emits light visible to a user removing a printed document; the printer can further comprise a control device that is able to transfer information to the exterior using the light source without adding further light emitting device, by means of a modulator that induces the light source for emitting a pulsed modulated light signal, in particular in a form that is not visible to the human eye; the modulated signal may contain information relating to the identity of the printer; the modulated signal may be received and decoded by an external decoder.

### BRIEF DESCRIPTION OF THE DRAWINGS

The invention can be better understood and implemented with reference to the attached drawings that illustrate an embodiment thereof by way of non-limiting example.

FIG. 1 is a diagram of an embodiment according to the invention of a ticket printer provided with at least one light source.

FIG. 2 is a diagram of the control system of the printer in FIG. 1.

FIG. 3 is an example of a graph of pulsed wave shapes containing information to be transmitted by the light source of the printer in FIG. 1.

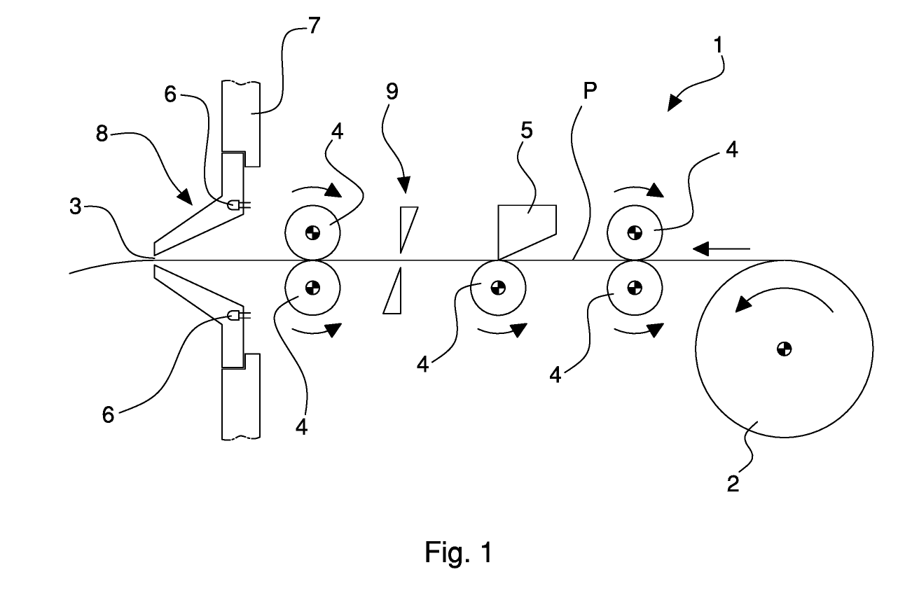

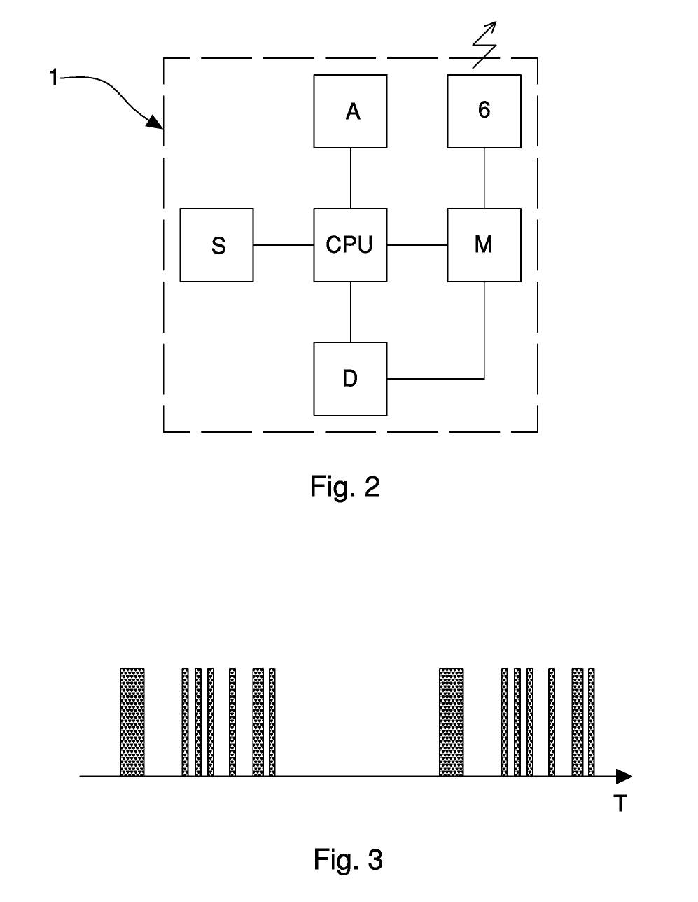

### DETAILED DESCRIPTION OF THE INVENTION

With reference to the above figure, overall with 1 a printer has been indicated, in particular a printer of tickets, receipts or slips. The printer may be, for example, a printer for dispensing a printed document in real time in public places.

The printer 1 may comprise a magazine 2 of a printing support P. The printing support P may comprise, for example, a (continuous) strip of paper, for example thermal paper, or of another printable material. The magazine 2 may comprise, as in this case, at least one reel. It is possible to provide other types of magazine or printing supports. It is possible to use, for example, a pack of single sheets of stacked paper, or a pack of “fan folder” sheets, etc.

The printer 1 may comprise a supply path of the printing support along which the printing support P proceeds (from the magazine 2) to an outlet 3. The outlet 3 may be arranged at the end of the aforesaid path. In particular, the outlet 3 may be arranged in such a manner that a user can remove the printed document.

The printer 1 may further comprise a supply arrangement for supplying the printing support P along the aforesaid path. Such supply arrangement may comprise, for example, one or more dragging rollers 4.

The printer 1 comprises a printing device for printing a document (ticket, receipt, or slip) on the printing support P, in particular along the aforesaid path. Such printing device may comprise, as in this example, a thermal printing head 5. The printing head 5 may comprise a dragging roller 4 facing and cooperating with the head 5 such that the printing support P advancing along the path is guided to pass between the thermal head 5 and the dragging roller 4.

The printer 1 may comprise an electronic control device (for example a CPU in the form of a circuit or board) for controlling actuators A of the printer (the supply arrangement and/or the printing device and/or other possible actuators). The (programmable) electronic control device may be arranged for receiving signals from a possible sensor arrangement S of the printer, for example a paper-finished sensor that signals that the magazine 2 is empty and/or a paper-present sensor that indicates the presence or lack of paper at a determined point of the supply path, etc.

The printer 1 comprises a light source arranged for emitting light, in particular light that is visible to the user withdrawing the printed document. The light source may comprise, as in the specific example, one or more LEDs 6.

The light source (LED 6) may be connected to the control device to emit light according to one or more predetermined operating states of the printer 1.

In particular the control device (CPU) may comprise an arrangement for controlling the light source in at least one operating mode in which the light source emits light that is visible to the user.

This operating mode may be activated, for example, in response to at least one operation performed and/or being performed and/or about to be performed by the supply arrangement and/or by the printing device and/or by other actuators. It is possible, for example, to program the control unit in such a manner that the light source emits light that is visible to the user for a certain time during printing and subsequent dispensing through the outlet 3 of the printed document by the printer 1.

The printer comprises a modulating device (for example a modulator M that may comprise an electronic circuit or board) for modulating a light emitted by the light source (LED 6) with a modulated signal that is able to convey predetermined useful information.

The signal that modulates the light emitted by the light source (LED 6) may convey, in particular, identifying information relating to the printer 1 or at least one component of the printer 1.

The conveying signal may be, for example, an amplitude modulated signal, or a frequency modulated signal. In particular, the modulating device (modulator M) may be programmed for modulating the light with the conveying signal so that the effect of this modulation is not visible to the human eye.

FIG. 3 shows a graph schematically, as a function of the time T, of a possible pulsed wave shape of the modulated light signal by means of the modulating device (modulator M). A given set of pulses may be, for example, emitted periodically, at preset intervals of time, or may be emitted in response to a preset external command sent by a user through a user (graphic) interface connected to the control device of the printer and/or through a preset (wireless) signal that is receivable by a receiver associated with the printer.

It is possible, as in this example, that a pulsed wave shape contains the information that is useful for transmitting to the exterior. It is possible to use any wave shape that is able to transmit a piece of information.

FIG. 3 shows a simplified diagram of the electronic control system of the printer, that may comprise a CPU circuit, configured for receiving signals from the sensor arrangement S of the printer and for transmitting signals to one or more actuators A of the printer 1 (printing device and/or paper supply arrangement and/or elements for separating the printed document), and/or a modulator circuit M, and/or a driving circuit D of the light source (LED 6).

The useful information to be transmitted by the modulation of the light signal may comprise, for example, a code identifying the origin of the printer (for example a manufacturing code or a counterfeiting code or the like), and/or information on the operations performed by the printer (for example the number and/or the type of tickets dispensed in a day, or the hours of accumulated work or the like), and/or information on faults or malfunctions that have occurred and/or on (scheduled or extraordinary) maintenance tasks to be performed, and/or information on the history of the printer (for example purchase date and/or installation date), etc.

The printer 1 may further comprise, as in the specific example, a case that may contain the magazine 2 of the printing support and/or the supply path of the printing support P or at least a part of this path and/or the supply arrangement of the printing support and/or the printing device of the document and/or other actuators A and/or the electronic control device (CPU) and/or the light source (LED 6) and/or the modulating device (modulator M) and/or the sensor arrangement S.

The case may comprise, for example, a (front) wall 7 that has an outlet mouth 8 that defines the outlet 3. The printed document will in this case be presented to the user through the outlet mouth 8.

The light source (LED 6) may be (at least in part) arranged near the outlet mouth 8. The outlet mouth 8 may be made, as in this case, of transparent plastics and the light source (LED 6) may be at least partially arranged embedded in the material of the outlet mouth 8. It is nevertheless possible to provide other arrangements of the light signal emitting device.

The printer may comprise, as in this case, a separating element (for example a stationary or movable cutter 9 commanded by the control device) to separate the printed document from the rest of the printing support P.

The information conveying signal modulates the light emitted by the light source (LED 6). This information conveying signal may be, for example, a signal of the type that is receivable from an external optoelectronic receiver. This information conveying signal may be decodeable by an external decoder.

The emitted light signal may thus be a pulsing signal according to the specific information to be transmitted. The emitted light signal may comprise a pulsed signal with a preset frequency and/or amplitude. The emitted light signal may comprise a pulsed signal that transmits information in a form that is encrypted and readable by a decoder.

The modulated light signal emitted by the printer 1 can be used in many different manners, in particular for identifying the printer and thus for distinguishing an original printer from a counterfeited clone, checking simply and rapidly the authenticity of the product by reading and possibly decoding the signal.

1-27. (canceled)

28. A printer comprising:
a magazine of a printing support;
a supply path of the printing support coming from said magazine;
a supply arrangement for supplying the printing support along said path;
a printing device for printing a document on the printing support along said path;
an outlet for withdrawing the printed document;
a control device for controlling said supply arrangement and/or said printing device;
a light source arranged for emitting light, in particular a light that is visible to a user who withdraws the printed document;
a modulating device for modulating a light emitted by said light source with a conveying signal of a preset piece of information;
wherein said modulating device modulates said light with said conveying signal in such a manner that the effect of said modulation is not visible to the human eye.

29. The printer according to claim 28, wherein said signal that modulates the light emitted by said light source conveys information in a form that is encrypted and readable by a decoder.

30. The printer according to claim 28, wherein said light source is connected to said control device to emit light according to one or more preset operating statuses of the printer.

31. The printer according to claim 30, wherein said control device comprises an arrangement for controlling said light source in at least one operating mode wherein said light source emits light that is visible to the user, said operating mode being activated in response to at least one operation performed by said supply arrangement and/or by said printing device.

32. The printer according to claim 28, wherein said conveying signal is an amplitude modulated signal.

33. The printer according to claim 28, wherein said conveying signal is a frequency modulated signal.

34. The printer according to claim 28, wherein said light source comprises one or more LEDs.

35. The printer according to claim 28, wherein said printer comprises a casing with a wall that has an outlet mouth that defines said outlet, said light source being arranged associated and/or near to said outlet mouth.

36. The printer according to claim 28, wherein said magazine comprises at least a roll of paper, said supply arrangement comprises at least one paper advancement roll and said printing device comprises at least one thermal printing head.

37. A printer comprising:
a magazine of a printing support;
a supply path of the printing support coming from said magazine;
a supply arrangement for supplying the printing support along said path;
a printing device for printing a document on the printing support along said path;
an outlet for withdrawing the printed document;
a control device for controlling said supply arrangement and/or said printing device;
a light source arranged for emitting light, in particular a light that is visible to a user who withdraws the printed document;
a modulating device for modulating a light emitted by said light source with a conveying signal of a preset piece of information;
wherein said conveying signal is an amplitude modulated signal.

38. The printer according to claim 37, wherein said signal that modulates the light emitted by said light source conveys information in a form that is encrypted and readable by a decoder.

39. The printer according to claim 37, wherein said modulating device modulates said light with said conveying signal in such a manner that the effect of said modulation is not visible to the human eye.

40. The printer according to claim 37, wherein said light source is connected to said control device to emit light according to one or more preset operating statuses of the printer.

41. The printer according to claim 40, wherein said control device comprises an arrangement for controlling said light source in at least one operating mode wherein said light source emits light that is visible to the user, said operating mode being activated in response to at least one operation performed by said supply arrangement and/or by said printing device.

42. The printer according to claim 37, wherein said conveying signal is a frequency modulated signal.

43. The printer according to claim 37, wherein said light source comprises one or more LEDs.

44. The printer according to claim 37, wherein said printer comprises a casing with a wall that has an outlet mouth that defines said outlet, said light source being arranged associated and/or near to said outlet mouth.

45. The printer according to claim 37, wherein said magazine comprises at least a roll of paper, said supply arrangement comprises at least one paper advancement roll and said printing device comprises at least one thermal printing head.

46. A printer comprising:
a magazine of a printing support;
a supply path of the printing support coming from said magazine;
a supply arrangement for supplying the printing support along said path;
a printing device for printing a document on the printing support along said path;
an outlet for withdrawing the printed document;
a control device for controlling said supply arrangement and/or said printing device;
a light source arranged for emitting light, in particular a light that is visible to a user who withdraws the printed document;
a modulating device for modulating a light emitted by said light source with a conveying signal of a preset piece of information;
wherein said signal that modulates the light emitted by said light source conveys information in a form that is encrypted and readable by a decoder.

47. The printer according to claim 46, wherein said modulating device modulates said light with said conveying signal in such a manner that the effect of said modulation is not visible to the human eye.

48. The printer according to claim 46, wherein said light source is connected to said control device to emit light according to one or more preset operating statuses of the printer.

49. The printer according to claim 48, wherein said control device comprises an arrangement for controlling said light source in at least one operating mode wherein said light source emits light that is visible to the user, said operating mode being activated in response to at least one operation performed by said supply arrangement and/or by said printing device.

50. The printer according to claim 46, wherein said conveying signal is an amplitude modulated signal.

51. The printer according to claim 46, wherein said conveying signal is a frequency modulated signal.

52. The printer according to claim 46, wherein said light source comprises one or more LEDs.

53. The printer according to claim 46, wherein said printer comprises a casing with a wall that has an outlet mouth that defines said outlet, said light source being arranged associated and/or near to said outlet mouth.

54. The printer according to claim 46, wherein said magazine comprises at least a roll of paper, said supply arrangement comprises at least one paper advancement roll and said printing device comprises at least one thermal printing head.
